(19) United States
(12) Patent Application Publication
(10) Pub. No.: US 2010/0041710 A1
(43) Pub. Date: Feb. 18, 2010

(54) PENETRATION ENHANCER FOR INSECTICIDES

(75) Inventors: Peter Baur, Schondorf (DE); Ronald Vermeer, Leverkusen (DE); Rainer Suessmann, Heinrich-Fendel (DE)

Correspondence Address: Baker Donelson Bearman, Caldwell & Berkowitz, PC, 555 Eleventh Street, NW, Sixth Floor, Washington, DC, 20004, US

(73) Assignee: BAYER CROPSCIENCE AG, MONHEIM (DE)

(21) Appl. No.: 12/519,410

(22) PCT Filed: Dec. 7, 2007
(86) PCT No.: PCT/EP07/10644

§ 371 Date: Jun. 16, 2009

(30) Foreign Application Priority Data
Dec. 18, 2006 (EP) 06026144.3

(51) Int. Cl. A01N 57/10; A01P 7/04; A01N 43/40; A01N 43/38

(52) U.S. Cl. 514/342; 514/143; 514/409

(57) ABSTRACT

Methods for enhancing penetration of agrochemical active substances through the cuticle of a plant are disclosed. Also disclosed are compositions comprising at least one penetration enhancer.

The invention relates to the field of chemical crop protection, in particular the use of a specific compound as a penetration enhancer for agrochemical active substances selected from the group consisting of the insecticides and crop protection agents containing this compound. The compound is tributoxyethyl phosphate (CAS reg. no.: 78-51-3; referred to below as TBEP).

The enhancement of penetration of insecticides in plants is brought about by ‘penetration enhancers’. The term penetration enhancer is understood as meaning compounds which accelerate the uptake of insecticides through the cuticle of a plant into the plant, i.e. the rate of uptake, and/or increase the amount of active substance absorbed into the plant, thus making it possible for the insecticides to become effective after the plant has been attacked by the harmful organisms.

Substances which increase the penetration of insecticides through the cuticle of the plant are valuable auxiliaries in chemical crop protection. Various classes of substances are already known as penetration enhancers (cf. for example WO 2005/104844 A). DE 3513889 A1 generally discusses penetration enhancers as an “activator” for biocides and EP 579052 A2 describes compounds selected from the group consisting of alkyl phosphates, such as tributyl phosphate and tripropyl phosphate, as penetration enhancers. Nevertheless, from various points of view, there is still a need for further compounds having more advantageous properties.

It is therefore an object of the invention to provide further advantageous substances having penetration-enhancing properties for agrochemical active substances.

It has now surprisingly been found that the solvent TBEP, in contrast to many other solvents, is suitable in certain relatively low application rates and in certain mixing ratios to the active substance for increasing the penetration of insecticides through the cuticle of the plant and thus for increasing the biological action of crop protection agents.

TBEP is already known as a solvent at appropriately high application rates in crop protection, such as in herbicides (cf. for example WO 01/47356 A1, EP 1251736 B1, WO 00/56146 A1, EP 1164842 B1) and insecticides (cf. for example JP 08291004 A, U.S. Pat. No. 5,674,517 A). GB 2022070 A discloses TBEP for defoliation, it being added in ratios (TBEP: active substance) of from 2:1 to 4:1 to herbicidal active substances. In the field of fungicides, the use of TBEP as a penetration enhancer appears to be as yet unknown.

The invention relates to a method for enhancing penetration, the components
(A) one or more active substances selected from the group consisting of the insecticides,
(B) tributoxyethyl phosphate (TBEP) in doses of from 2.5 to 150.0 g/ha and
(C) optionally one or more emulsifiers, preferably selected from the group consisting of the ionic and nonionic emulsifiers and mixtures thereof having HLB values of from 10 to 17,
   being applied simultaneously or sequentially to the plants affected by the harmful organisms.

The invention also relates to the use of the method described here, the components being applied simultaneously or sequentially to the plants attacked by the harmful organisms.

Since the action mechanism of TBEP as a penetration enhancer is in principle independent of the type of agrochemical active substance used, all active substances selected from the group consisting of the insecticides, whose biological activity against insects in the wider sense, referred to below as harmful organisms, can be increased by greater penetration into the crop plant, are suitable.

Active substances selected from the group consisting of the insecticides, also comprising acaricides, nematicides, molluscicides, rodenticides, repellents, and also plant nutrients which have systemic properties and contact agents suitable as combination partners may preferably be mentioned. Below, the term insecticides includes both insecticides and acaricides, nematicides and molluscicides, rodenticides and repellents, unless evident otherwise from the context.

Also preferably within the abovementioned groups are systemic active substances, i.e. those which are taken up by the plant through the leaves or via the roots and are distributed in the sap stream, the transport system or plant. Particularly preferred active substances are those which have a log P value≦4 (determined according to EEC Directive 79/831 Annex V. A8 by HPLC, gradient method, acetonitrile/0.1% aqueous phosphoric acid), in particular those having a log P value of ≦4 and ≧0.1.

Examples of individual active substances selected from the group consisting of the insecticides, also including acaricides and/or nematicides, are:

Acetylcholinesterase (AChE) inhibitors
carbamates,
for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate
organophosphates,
for example acephate, azamethiphos, azinphos (methyl, ethyl), bromophosethyl, bromfenvinfos (methyl), butathiofos, cadusafos, carbophenothion, chlorethoxyfos, chlorfenvinphos, chlormephos, chlorpyrifos (methyl/ethyl), coumaphos, cyanofenphos, cyanophos, chlorfen-vinphos, demeton-s-methyl, demeton-s-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iproben-fos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (methyl/ethyl), phenthoate, phorate, phosalone, phosmet, phosphamidon, phosphocarb, phoxim, pirimiphos (methyl/ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion
   Sodium channel modulators/voltage-dependent sodium channel blockers
pyrethroids,
for example acrinathrin, allethrin (d-cis-trans, d-trans), beta-cyfluthrin, bifenthrin, bioallethrin, bioallethrin-5-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (-1R-isomer), tralomethrin, transfluthrin, ZXI 8901, pyrethrins (pyrethrum)
DDT
oxadiazines,
for example indoxacarb
semicarbazone,
for example metaflumizone (BAS3201)
   Acetylcholine receptor agonists/antagonists
chloronicotinyls,
for example acetamiprid, clothianidin, dinotefuran, imidacloprid, nitenpyram, nithiazine, thiacloprid, thiamethoxam
nicotine, bensultap, cartap
   Acetylcholine receptor modulators
spinosyns,
for example spinosad
   GABA-controlled chloride channel antagonists
organochlorines,
for example camphechlor, chlordane, endosulfan, gamma-HCH, HCH, heptachlor, lindane, methoxychlor
fiproles,
for example acetoprole, ethiprole, fipronil, pyrafluprole, pyriprole, vaniliprole
   Chloride channel activators
mectins,
for example abamectin, emamectin, emamectin benzoate, ivermectin, lepimectin, milbemycin
   Juvenile hormone mimetics
for example diofenolan, epofenonane, fenoxycarb, hydroprene, kinoprene, methoprene, pyri-proxifen, triprene
   Ecdyson agonists/disruptors
diacylhydrazines,
for example chromafenozide, halofenozide, methoxyfenozide, tebufenozide
   Inhibitors of chitin biosynthesis
benzoylureas,
for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron
buprofezin
cyromazine
   Inhibitors of oxidative phosphorylation, ATP disruptors
diafenthiuron
organotin compounds,
for example azocyclotin, cyhexatin, fenbutatin-oxide
   Decouplers of oxidative phosphorylation by interruption of the H-proton gradient
pyrroles,
for example chlorfenapyr
dinitrophenols,
for example binapacyrl, dinobuton, dinocap, DNOC
   Site I electron transport inhibitors
METIs,
for example fenazaquin, fenpyroximate, pyrimidifen, pyridaben, tebufenpyrad, tolfenpyrad
hydramethylnon
Dicofol
   Site II electron transport inhibitors
rotenone
   Site III electron transport inhibitors
acequinocyl, fluacrypyrim
   Microbial disruptors of the insect intestinal membrane
Bacillus thuringiensis strains
   Inhibitors of fat synthesis
tetronic acids,
for example spirodiclofen, spiromesifen
tetramic acids,
for example spirotetramat
carboxamides,
for example flonicamid
octopaminergic agonists,
for example amitraz
   Inhibitors of magnesium-stimulated ATPase,
propargite
Nereistoxin analogs,
for example thiocyclam hydrogen oxalate, thiosultap-sodium
   Agonists of the ryanodin receptor,
benzoic acid dicarboxamides,
for example flubendiamide
anthranilamides,
for example DPX E2Y45 (3-bromo-N-{4-chloro-2-methyl-6-[(methylamino)carbonyl]phenyl}-1-(3-chloropyridin-2-yl)-1H-pyrazole-5-carboxamide)
   Biologicals, hormones or pheromones
azadirachtin, Bacillus spec., Beauveria spec., codlemone, Metarrhizium spec., Paecilomyces spec., thuringiensin, Verticillium spec.
   Active substances having unknown or unspecific action mechanisms
feeding inhibitors
for example cryolite, flonicamid, pymetrozine
Mite growth inhibitors,
for example clofentezine, etoxazole, hexythiazox
amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin.

The abovementioned insecticides (acaricides, nematicides) are, for example, known from “The Pesticide Manual”, 12th edition (2000) to 14th edition (2006), The British Crop Protection Council or the literature references mentioned after the individual active substances.

Preferred insecticides are those from the group consisting of the acetylcholine receptor agonists/antagonists, preferably chloronicotinyls (neonicotinoids), such as acetamiprid, clothianidin, dinotefuran, imidacloprid, nitenpyram, nithiazine, thiacloprid, thiamethoxam, in particular imidacloprid and thiacloprid, and from the group consisting of the inhibitors of fat synthesis, preferably tetramic acids, such as spirotetramat.

The crop protection agents used in the method according to the invention contain as a rule from 0.01 to 99% by weight, in particular from 0.1 to 95% by weight, of the active substances selected from the group consisting of the insecticides. The application rates per unit area of the component (A) are in general between 10 and 2000 g AS/ha (AS=active substance, i.e. application rate based on the active substance), preferably between 50 and 300 g AS/ha.

Tributoxyethyl phosphate (TBEP) as component (B) has the CAS reg. no.: 78-51-3 and is described in detail in its further properties under this entry in technical literature.

The content of TBEP (B) in the crop protection agents used in the method according to the invention is dependent on the application rate per unit area, i.e. per hectare (ha) and must therefore be adapted appropriately. This also applies to the preparation of an application solution, for example a spray liquor, with the use of the method according to the invention. The application rates per unit area for TBEP (B) are between 0.5 and 150 g/ha, preferably from 1 to 50 g/ha, particularly preferably from 5 to 20 g/ha, the volume of the spray liquor being as a rule 100-1000 l/ha.

If appropriate, the addition of one or more emulsifiers may be necessary as component (C) in the preparation of crop protection agents used in the method according to the invention and/or the application according to the method according to the invention, preferably in the form of spray liquors. Suitable emulsifiers are selected from the group consisting of the ionic and nonionic emulsifiers and mixtures thereof having HLB values of from 10 to 17 (e.g. emulsifier 1371B). They can be added either directly and/or through the formulation of the components (A) and/or (B).

All customary formulation auxiliaries, such as organic solvents, antifoams, emulsifiers differing from component (C), dispersants, preservatives, acids and bases, dyes, fillers and also water, are suitable as further auxiliaries and additives (component D) which may be present in the formulations which are preferably liquid according to the method according to the invention.

Suitable organic solvents are all customary organic solvents which readily dissolve the agrochemical active substances used. Aliphatic and aromatic, optionally halogenated hydrocarbons, such as toluene, xylene, Solvesso®, vegetable and mineral oils, such as mineral spirit, petroleum, alkylbenzenes and spindle oil, and furthermore propylene carbonate, tetrachloromethane, chloroform, methylene chloride and dichloromethane, and additionally esters, such as ethyl acetate, lactates and furthermore lactones, such as butyrolactone, and additionally lactams, such as N-methylpyrrolidone, N-octylpyrrolidone, N-dodecylpyrrolidone N-octylcaprolactam and N-methylcaprolactam, γ-butyrolactone, dimethylformamide, and tributyl phosphate, may preferably be mentioned.

Suitable antifoams are customary antifoams present in formulations of agrochemical active substances. Silicone oils, dispersions of silicone oils, magnesium stearate, phosphinic and phosphonic acids, in particular Fluowet PL 80® may be mentioned by way of example.

Suitable emulsifiers differing from component (C) are customary surface-active substances present in formulations of agrochemical active substances. Ethoxylated nonylphenols, polyethylene glycol ether of linear alcohols, alkoxylated linear and branched saturated and unsaturated alcohols which are endcapped and those which are not endcapped, reaction products of alkylphenols with ethylene oxide and/or propylene oxide, ethylene oxide-propylene oxide block copolymers, polyethylene glycols and polypropylene glycols, and furthermore fatty acid esters, alkoxylated linear and branched, saturated or unsaturated fatty acids which are endcapped and those which are not endcapped, alkanesulfonates, alkylsulfates, alkyl ether sulfates, arylsulfates, ethoxylated arylalkylphenols, such as, for example, tristyrylphenol ethoxylate having on average 16 ethylene oxide units per molecule, and furthermore ethoxylated and propoxylated arylalkylphenols and sulfated or phosphated arylalkylphenol ethoxylates or ethoxy- and propoxylates may be mentioned by way of example.

Suitable dispersants are substances usually used in crop protection agents for this purpose. In addition to the compounds mentioned above under emulsifiers differing from component (C), natural and synthetic, water-soluble polymers, such as gelatin, starch and cellulose derivatives, in particular cellulose esters and cellulose ethers, and furthermore polyvinyl alcohol, polyvinylpyrrolidone, polyacrylic acid, ligninsulfonates, polymethacrylic acid and copolymers of (meth)acrylic acid and of (meth)acrylates, and also copolymers of methacrylic acid and methacrylates, which copolymers have been neutralized with alkali metal hydroxide, may preferably be mentioned.

Suitable preservatives are all substances usually present for this purpose in crop treatment agents. Preventol® and Proxel® may be mentioned as examples.

Suitable dyes are all inorganic or organic dyes customary for the preparation of crop protection agents. Titanium dioxide, carbon black, zinc oxide and blue pigments may be mentioned by way of example.

Suitable fillers are all substances usually used for this purpose in crop protection agents. Inorganic particles, such as carbonates, silicates and oxides, having a mean particle size of from 0.005 to 10 μm, particularly preferably from 0.02 to 2 μm, may preferably be mentioned. Silicon dioxide, so-called colloidal silica, silica gels and natural and synthetic silicates and aluminosilicates may be mentioned by way of example.

Suitable compounds which act as emulsion stabilizers and/or crystallization inhibitors are all substances usually used for this purpose in crop protection agents.

The content of the individual components in the crop protection agents used in the methods according to the invention and the application rate per unit area with the use of the method according to the invention can be varied within a relatively large range.

The formulation types suitable for the crop protection agents used in the methods according to the invention and comprising the components (A) and (B) and optionally the components (C) and/or (D) include in principle all formulations which are applied to plants or plant propagation material. The processes used for the preparation thereof are generally familiar to the person skilled in the art and are described, for example, in Winnacker-Küchler, “Chemische Technologie [Chemical Technology]”, volume 7, C. Hanser Verlag Munich, 4th edition, 1986; J. W. van Valkenburg, “Pesticide Formulations”, Marcel Dekker N.Y., 1973, K. Martens, “Spray Drying Handbook”, 3rd Ed. 1979, G. Goodwin Ltd., London, or Mollet, Grubenmann, “Formulierungstechnik [Formulation Technology]”, Wiley-VCH-Verlag, Weinheim, 2000.

In addition, in principle all formulation types are also suitable for the individual components of the method according to the invention.

Examples of formulation types are those mentioned in “Manual on development and use of FAO and WHO specifications for pesticides” (FAO and WHO, 2002, appendix E) (in each case use of the GCPF formulation codes with the English abbreviation and designation): AL Any other liquid; AP Any other powder; CF Capsule Suspension for Seed Treatment; CG Encapsulated granule; CL Contact liquid or gel; CP Contact powder; CS Capsule suspension; DC Dispersible concentrate; DP Dustable powder; DS Powder for dry seed treatment; EC Emulsifiable concentrate; ED Electrochargeable liquid; EG Emulsifiable Granule; EO Emulsion, water in oil; EP emulsifiable powder; ES Emulsion for seed treatment; EW Emulsion, oil in water; FG Fine granule; FS Flowable concentrate for seed treatment; GF Gel for Seed Treatment; GG Macrogranule; GL Emulsifiable gel; GP Flo-dust; GR Granule; GS Grease; GW Water soluble gel; HN Hot fogging concentrate; KK Combi-pack solid/liquid; KL Combi-pack liquid/liquid; KN Cold fogging concentrate; KP Combi-pack solid/solid; LA Lacquer; LS Solution for seed treatment; ME Micro-emulsion; MG Microgranule; OD Oil dispersion; OF Oil miscible flowable concentrate/oil miscible suspension; OL Oil miscible liquid; OP Oil dispersible powder; PA Paste; PC Gel or paste concentrate; PO Pour-on; PR Plant rodlet; PT Pellet; SA Spot-on; SC suspension concentrate; SD suspension concentrate for direct application; SE Suspo-emulsion; SG Water soluble granule; SL Soluble concentrate; SO Spreading oil; SP Water soluble powder; SS Water soluble powder for seed treatment; ST Water soluble tablet; SU Ultra-low volume (ULV) suspension; TB Tablet; TC Technical material; TK Technical concentrate; UL Ultra-low volume (ULV) liquid; WG Water dispersible granules; WP Wettable powder; WS Water dispersible powder for slurry seed treatment; WT Water dispersible tablet; XX Others.

Liquid formulation types are preferred. These include formulation types OD Oil dispersion; DC (GCPF formulation code for dispersible concentrate); EC (GCPF formulation code for emulsion concentrate); EW (GCPF formulation code for oil-in-water emulsion); ES (GCPF formulation code for an emulsion for seed treatment); FS (GCPF formulation code for flowable concentrate for seed treatment); EO (GCPF formulation code for water-in-oil emulsion); ME (GCPF formulation code for microemulsion); SE (GCPF formulation code for suspoemulsion); SL (GCPF formulation code for water-soluble concentrate); CS (GCPF formulation code for capsule suspension) and AL (GCPF formulation code for ready-to-use liquid formulation, other liquids for use in undiluted form).

Oil dispersions (syn. oil dispersion; formulation type OD) and emulsion concentrates (formulation type EC) are particularly preferred.

In spray powders, the active substance concentration is, for example, from about 10 to 90% by weight; the remainder to 100% by weight consists of TBEP (B) and customary formulation constituents (emulsifier, auxiliaries and additives), which is true for all formulations. In the case of emulsifiable concentrates, the active substance concentration may be from about 1 to 90, preferably from 5 to 80, % by weight. Dust-like formulations contain from 1 to 30% by weight of active substance, preferably in general from 5 to 20% by weight of active substance, and sprayable solutions contain from about 0.05 to 80, preferably from 2 to 50, % by weight of active substance. In the case of water-dispersible granules, the active substance content depends in some cases on whether the active compound is present in liquid or solid form and which granulation auxiliaries, fillers, etc. are used. In the case of the granules dispersible in water, the content of active substance is, for example, between 1 and 95% by weight, preferably between 10 and 80% by weight. In the case of oil dispersions, the active substance concentration may be from about 1 to 50, preferably from 3 to 30, % by weight.

The invention furthermore relates to a method for controlling harmful organisms, preferably harmful animals, preferably harmful arthropods, such as insects and arachnids, helminths and molluscs, more preferably harmful arthropods and helminths, the components used in the method according to the invention being applied to the plants affected by the harmful organisms, preferably in an effective amount.

Furthermore, the invention also relates to a method according to the invention, containing at least the components (A) and (B) which, in a preferred embodiment, show superadditive effects (synergism). Owing to the improved control of the harmful organisms by the methods according to the invention, it is possible to lower the application rate and/or to increase the safety margins. Both are both economically and ecologically expedient. The choice of the amounts of the components (A) and (B) to be used and the ratio of the components (A):(B) are dependent on a whole range of factors.

The preparation of the crop protection agents used in the methods according to the invention is effected, for example, by a procedure in which the components are mixed with one another in the respective desired ratios. If the insecticide designated below as agrochemical active substances, is a solid substance, it is generally used either in finely milled form or in the form of solution or suspension in an organic solvent or water. If the agrochemical active substance is liquid, the use of an organic solvent is frequently superfluous. It is also possible to use a solid agrochemical active substance in the form of a melt.

While the method is being carried out, the temperatures may be varied within a certain range. In general, temperatures between 0° C. and 80° C., preferably between 10° C. and 60° C., are employed.

For the preparation of the crop protection agents used in the methods according to the invention, in general a procedure is adopted in which TBEP (B) is mixed with one or more of the agrochemical active substances (A) and optionally with the emulsifier (C) and the auxiliaries and additives (D). The sequence in which the components are mixed with one another depends on the respective formulation type.

Customary apparatuses which are used for the preparation of agrochemical formulations are suitable for carrying out the preparation process.

All methods known by a person skilled in the art to be customary can be used as application forms for use of the crop protection agent used in the methods according to the invention and for carrying out the method according to the invention; the following may be mentioned by way of example: spraying, immersion, application as a mist and a number of special methods for direct underground of above-ground treatment of entire plants or parts (seed, root, stolons, stalks, trunk, foliage), such as, for example, trunk injection in the case of trees or stalk bandages in the case of perennial plants, and a number of special indirect application methods.

The respective application rate per unit area and/or per object of the crop protection agents of a very wide range of formulation types which are used in the methods according to the invention and of the method according to the invention for controlling said harmful organisms varies very greatly. In general, the application media known to a person skilled in the art as being customary for the respective field of use are used for this purpose in the customary amounts; such as, for example, several hundred liters of water per hectare in the case of standard spray methods to a few liters of oil per hectare in the case of the ultra low volume aircraft application to a few millimeters of a physiological solution in the case of injection methods. The concentrations of the crop protection agents used in the methods according to the invention in the corresponding application media therefore vary within a wide range and are dependent on the respective field of use. In general, concentrations which are known to the person skilled in the art as being customary for the respective field of use are used. Concentrations of from 0.01% by weight to 99% by weight, particularly preferably from 0.1% by weight to 90% by weight, are preferred.

The crop protection agents of a very wide range of formulation types which are used in the methods according to the invention, as well as the components necessary for carrying out the method according to the invention, can be applied, for example, in the formulation forms customary for liquid preparations, either as such or after prior dilution with water, i.e. for example as emulsions, suspensions or solutions. The application is effected by the customary methods, i.e. for example by spraying, pouring or injection.

The application rate of the crop protection agents of a very wide range of formulation types which are used in the methods according to the invention, as well as the components necessary for carrying out the method according to the invention, can be varied within a relatively large range. It depends on the respective insecticides and on the content thereof in the formulations.

In the method according to the invention for enhancing the penetration of active substances into plants, the TBEP (B) to be used is as a rule applied together with the active substance or substances (A) or directly in succession, preferably in the form of a spray liquor which contains TBEP (B) in amounts according to the invention and the active substance or substances (A) in effective amounts and optionally one or more emulsifiers (C). In addition, further customary auxiliaries and additives can be added. The spray liquor is preferably prepared on the basis of water and/or an oil, for example the high-boiling hydrocarbon, such as kerosene or paraffin. The components for the method according to the invention can be realized either as a tank mix or via a ready-to-use formulation (coformulation).

In the case of harmful animals, the application to plants to be protected from these harmful organisms is preferred. This does not include methods for therapeutic use in humans and animals.

The plants treated according to the invention are all types of crop plants. With regard to the protection of crop plants by applying insecticides, the application in economically important, for example including transgenic, crops of useful and ornamental plants, for example of cereals, such as wheat, barley, rye, oats, millet, rice, cassaya and corn, or crops of peanuts, sugar beet, cotton, soybean, rape, potato, tomato, pea and other vegetable varieties is preferred.

The crop protection agents used in the methods according to the invention, and the methods according to the invention, have a number of advantages. Thus, the general penetration of the active substances into the plant tissue is substantially improved by TBEP. The faster onset of penetration thus also results in a higher resistance to rain. At the same time, the penetration at relatively low temperatures (for example less than 15° C.) is improved. With regard to the crop plant tolerance, TBEP proved to be more tolerant than other alkyl ester additives in tests. Overall, use of TBEP therefore permits savings of the active substances used. In addition, TBEP results in less environmental pollution since it has reduced volatility.

The invention is illustrated in more detail by the examples without limiting them thereto.

### EXAMPLES

### Penetration Test

In this test, the penetration of active substances through enzymatically isolated cuticles of apple tree leaves was measured. The cuticles represent all green plant parts, such as leaf blade, petiole, stalk, trunk, hypocotyl and many fruits.

Leaves which were cut off in the stage of full development of apple trees of the Golden Delicious variety were used. The isolation of the cuticles was effected in a manner such that
first, leaf disks marked on the underside with dye and punched out were filled by means of vacuum infiltration with a pectinase solution (0.2 to 2% strength by weight) buffered to a pH between 3 and 4,
sodium azide was then added and
the leaf disks thus treated were allowed to stand until disintegration of the original leaf structure and detachment of the noncellular cuticle.

Thereafter, only those cuticles of the upper sides of the leaves which were free of stomata and hairs were further used. They were washed several times alternately with water and a buffer solution at pH 7. The cleaned cuticles obtained were finally drawn onto small Teflon plates and smoothed and dried with a gentle air jet.

In the next step, the cuticle membranes thus obtained were placed in stainless steel diffusion cells (=transport chambers) for membrane transport investigations. For this purpose, the cuticles were placed by means of forceps centrally on the silicone grease-coated edges of the diffusion cells and closed with a likewise greased ring. The arrangement was chosen so that the morphological outside of the cuticles faced outward, i.e. toward the air, while the original inside faced the interior of the diffusion cell. The diffusion cells were filled with water or with a mixture of water and solvent.

For determining the penetration, in each case 10 μl of a spray liquor of the composition mentioned in the examples were applied to the outside of a cuticle.

In each case the solvents listed below in the table (tap water or a mixture with 20% by weight of acetone/80% by weight of tap water) were used in the spray liquors.

After the application of the spray liquors, in each case the solvent was allowed to evaporate, and in each case the chambers were then turned around and placed in thermostated trays, air having a defined temperature and atmospheric humidity being blown onto the outside of the cuticle. The incipient penetration therefore took place at a relative humidity of 60% and a set temperature of 20 or 25° C. The active substance penetration was measured with radioactively marked active substance.

TABLE 1
Penetration* of thiacloprid (insecticide) by TBEP
(emulsified) in comparison with the control*

| Active substance without/ | % Penetration | % Penetration |
|---|---|---|
| with TBEP | after 3 h** | after 24 h** |
| 0.18 g/l of thiacloprid (A) | 0.1 | 0.8 |
| without TBEP | | |
| 0.18 g/l of thiacloprid (A) + | 3.9 | 6.6 |
| 0.21 g/l of TBEP (B) + | | |
| 0.09 g/l of emulsifier 1371B (C) | | |
| 0.18 g/l of thiacloprid (A) + | 23.3 | 41.5 |
| 0.7 g/l of TBEP (B) + | | |
| 0.3 g/l of emulsifier 1371B (C) | | |
| 0.18 g/l of thiacloprid (A) + | 47.2 | 89.3 |
| 2.1 g/l of TBEP (B) + | | |
| 0.9 g/l of emulsifier 1371B (C) | | |

*Active substance dissolved in tap water;
**Mean values of 4-8 repetitions for the penetration through apple leaf cuticles (temperature = 20° C., rel. humidity 60%); thiacloprid (manufacturer Bayer CropScience).

TABLE 2
Enhancement of penetration of various insecticides*
by TBEP in comparison with the control

| Active substance without/ | % Penetration | % Penetration |
|---|---|---|
| with TBEP | after 3 h** | after 48 h** |
| Insecticide | 0.1 | 1.0 |
| 0.3 g/l of thiacloprid (A) | | |
| 0.3 g/l of thiacloprid (A) + | 43.5 | 90 |
| 2.0 g/l of TBEP (B) | | |
| Insecticide | 0 | 0.3 |
| 0.3 g/l of spirotetramat (A) | | |
| 0.3 g/l of spirotetramat (A) + | 11.5 | 38.1 |
| 2.0 g/l TBEP (B) | | |

*Active substance dissolved in tap water (thiacloprid) or a mixture of acetone/tap water (20/80% by weight spirotetramat);
**Mean values of 4-8 repetitions for the penetration through apple leaf cuticles (temperature = 20-25° C., rel. humidity 56-60%); thiacloprid (manufacturer Bayer CropScience), spirotetramat (cis-3-(2,5-dimethylphenyl)-8-methoxy-2-oxo-1-azaspiro[4.5]dec-3-en-4-yl ethyl carbonate, manufacturer Bayer CropScience).
As is evident from the examples shown in tables 1 and 2, TBEP leads to a substantial increase in uptake of the active substance.

TABLE 3
Comparative experiments for different compounds as penetration
enhancers of the insecticidal active substance imidacloprid*

| Active substance without/ | % Penetration | % Penetration |
|---|---|---|
| with penetration enhancer*** | after 3 h** | after 24 h** |
| Insecticide | 0.3 | 0.5 |
| 0.1 g/l of imidacloprid (A) | | |
| 0.1 g/l of imidacloprid (A) + | 58 | 80 |
| 2 g/l of TBP (B) | | |
| 0.1 g/l of imidacloprid (A) + | 63 | 74 |
| 2 g/l of TBP (B) + | | |
| 0.1 g/l of emulsifier 1371B (C) | | |
| 0.1 g/l of imidacloprid (A) + | 26 | 37 |
| 2 g/l of TPP (B) | | |
| 0.1 g/l of imidacloprid (A) + | 19 | 31 |
| 2 g/l of TPP (B) + | | |
| 0.1 g/l of emulsifier 1371B (C) | | |
| 0.1 g/l of imidacloprid (A) + | 69 | 92 |
| 2 g/l of TBEP (B) | | |
| 0.1 g/l of imidacloprid (A) + | 75 | 88 |
| 2 g/l of TBEP (B) + | | |
| 0.1 g/l of emulsifier 1371B (C) | | |

*Active substance dissolved in tap water;
**mean values of 10 repetitions for the penetration through apple leaf cuticles (temperature = 20-25° C., rel. humidity 56-60%); imidacloprid (manufacturer Bayer CropScience);
***TBP = tributyl phosphate and TPP = tripropyl phosphate (prior art: EP 579052 A2); TBEP = tributoxyethyl phosphate (according to the invention).

As is evident from the examples shown in table 3, the TBEP according to the invention leads to an advantageously higher increase in uptake of active substances than the penetration enhancers of the prior art. This result is surprising and was not to be expected in view of the prior art.

1. A method for enhancing penetration of an agrochemical active compound in a plant, said method comprising applying,
(A) at least one active substance selected from the group consisting of the agrochemical active compounds,
(B) tributoxyethyl phosphate (TBEP) in an amount of from 2.5 to 150.0 g/ha and
(C) optionally one or more emulsifiers,
wherein said components (A), (B) and optionally (C) are applied simultaneously and/or sequentially to a plant that could be, attacked by harmful organisms.

2. A method as claimed in claim 1, wherein the components A, B, and C are applied simultaneously or sequentially to a plant capable of being attacked by harmful organisms.

3. A method for controlling harmful organisms, comprising applying to a plant capable of being attacked by harmful organisms, the following components:
(A) at least one active substance selected from the group consisting of the agrochemical active compounds,
(B) tributoxyethyl phosphate (TBEP) in an amount of from 2.5 to 150.0 g/ha and
(C) optionally one or more emulsifiers.

4. A combination for enhancing penetration of an agrochemical compound comprising:
(A) at least one active substance selected from the group consisting of the agrochemical active compounds,
(B) tributoxyethyl phosphate (TBEP) in an amount of from 2.5 to 150.0 g/ha and
(C) optionally one or more emulsifiers.

5. A method of claim 1, wherein said agrochemical active compound comprises an insecticide.

6. A method of claim 3, wherein said agrochemical active compound comprises an insecticide.

7. A combination of claim 4, where said agrochemical active compound comprises an insecticide.

8. A method of claim 1, wherein said emulsifier is at least one selected from the group consisting of ionic and nonionic imulsifiers having an HLB value of from 10 to 7.

9. A method of claim 2, wherein said emulsifier is at least one selected from the group consisting of ionic and nonionic emulsifiers having an HLB value of from 10 to 7.

10. A method of claim 3, wherein said emulsifier is at least one selected from the group consisting of ionic and nonionic emulsifiers having an HLB value of from 10 to 7.

11. A combination of claim 4, wherein said emulsifier is at least one selected from the group consisting of ionic and nonionic emulsifiers having an HLB value of from 10 to 7.

12. A method of claim 5, wherein said emulsifier is at least one selected from the group consisting of ionic and nonionic emulsifiers having an HLB value of from 10 to 7.

13. A method of claim 6, wherein said emulsifier is at least one selected from the group consisting of ionic and nonionic emulsifiers having an HLB value of from 10 to 7.

14. A method of claim 7, wherein said emulsifier is at least one selected from the group consisting of ionic and nonionic emulsifiers having an HLB value of from 10 to 7.
